(19) United States
(12) Patent Application Publication
(10) Pub. No.: US 2026/0299152 A1
(43) Pub. Date: Oct. 1, 2026

(54) EXPERIMENTAL METHOD FOR FLUID-INJECTION-INDUCED SEISMICITY UNDER TRUE-TRIAXIAL STRESS CONDITIONS

(71) Applicant: TIANJIN UNIVERSITY, Tianjin (CN)

(72) Inventors: Kaiwen XIA, Tianjin (CN); Chonglang WANG, Tianjin (CN); Ying XU, Tianjin (CN); Bangbiao WU, Tianjin (CN); Wei YAO, Tianjin (CN); Peng DONG, Tianjin (CN); Senmiao ZHU, Tianjin (CN)

(73) Assignee: TIANJIN UNIVERSITY, Tianjin (CN)

(21) Appl. No.: 19/428,377

(22) Filed: Dec. 22, 2025

(30) Foreign Application Priority Data
Mar. 31, 2025 (CN) 2025103943513

(51) Int. Cl. G01V 1/30; G01V 1/01; G01V 1/133; G01V 1/28

(52) U.S. Cl. CPC G01V 1/306; G01V 1/01; G01V 1/133; G01V 1/282

(57) ABSTRACT

An experimental method for fluid-injection-induced seismicity under true-triaxial stress conditions involves: fabricating a cubic rock model containing a fault, diagonally cutting the model to form a fault plane, and arranging a water-injection borehole and pore-pressure monitoring boreholes; after injecting water to permeate and saturate the fault plane, applying triaxial differential stresses via a true-triaxial loading apparatus and maintaining stable stress states; then inducing spontaneous instability in the fault model via displacement control, calculating an interseismic period, finally setting cycling or a constant-rate injection scheme to simulate industrial fluid activities, thereby investigating a mechanism of water injection-induced seismicity. The experimental method for fluid-injection-induced seismicity under true-triaxial stress conditions enables precise simulation of in-situ formation stress and injection conditions, providing a reliable method to study injection-induced seismicity, thereby holding significant implications for seismicity prediction, geohazard prevention and control, and related industrial safety.

### CROSS REFERENCE TO THE RELATED APPLICATIONS

This application is based upon and claims priority to Chinese Patent Application No. 202510394351.3, filed on Mar. 31, 2025, the entire contents of which are incorporated herein by reference.

### TECHNICAL FIELD

The present invention belongs to the technical field of geoscience experimentation, and particularly relates to an experimental method for fluid-injection-induced seismicity under true-triaxial stress conditions.

### BACKGROUND

With the acceleration of global industrialization, the demand for energy continues to rise, leading to an increasing scale of industrial activities such as hydraulic fracturing and wastewater injection. During such activities, substantial volumes of high-pressure water are forcibly injected into subsurface. Faults are widely distributed in complex subsurface geological structures. The injection of high-pressure water may disturb the pre-existing stress equilibrium across a fault, potentially leading to fault reactivation. When a fault is reactivated, unstable slip may occur, potentially inducing seismic activity. In severe scenarios, such events may potentially trigger destructive seismic activity, thereby posing substantial threats to human life, property assets, and the ecological environment.

To gain an in-depth understanding of seismic nucleation processes and governing mechanisms, laboratory-based induced seismicity experimentation has been developed. In terms of experimental loading methods, the current approaches are primarily classified into categories such as direct-shear injection tests, biaxial injection tests, and triaxial injection tests.

Among various experimental methods, the triaxial injection test is the most widely used due to the capability to simulate subsurface stress conditions effectively. Existing triaxial injection test apparatuses are predominantly adapted from conventional triaxial cells for confining pressure. However, in-situ geological conditions surrounding faults exhibit a true-triaxial stress state, wherein the magnitudes of the three principal stresses differ from each other. It is apparent that existing triaxial pressure injection apparatuses and methods based on confining pressure are incapable of accurately simulating the stress state of a fault within a real in-situ stratum, thus exhibiting significant limitations. In contrast, the true triaxial injection device more closely approximates actual induced seismicity scenarios. The system demonstrates superior effectiveness and innovative potential in induced seismicity research, thereby facilitating enhanced revelation of the internal mechanisms governing fluid-injection-induced earthquakes. Consequently, the true triaxial injection apparatus demonstrates significantly improved effectiveness and heightened innovation in induced seismicity research, thereby more effectively elucidating the inherent mechanisms underlying injection-induced seismicity. Existing true triaxial water injection apparatuses primarily focus on experiments for rock seepage or fault instability, but lack systematic and targeted approaches for simulating the complex process of injection-induced seismicity. Particularly in the design of the injection steps, the various injection methods employed in actual industrial activities and the complex physical processes associated with earthquake occurrence are not fully considered.

### SUMMARY

An objective of the present invention is to provide an experimental method for fluid-injection-induced seismicity under true-triaxial stress conditions, so as to solve the problem set forth in the background art concerning how to accurately replicate, within a laboratory environment, the complete process whereby water injection operations induce fault destabilization, ultimately resulting in seismicity under complex subterranean conditions characterized by three mutually unequal principal stresses.

To achieve the foregoing objective, the present invention provides the following technical solution: an experimental method for fluid-injection-induced seismicity under true-triaxial stress conditions, including the steps of:
S1. fabricating a cubic rock model with side lengths of a cm×a cm×a cm using rock material, diagonally cutting the cubic rock model along a diagonal plane to form a fault plane, drilling a water-injection borehole from a center of a footwall bottom toward the fault plane, and uniformly arranging pore-pressure monitoring boreholes along the fault plane;
S2. coupling a high-precision high-pressure water pump to the water-injection borehole and injecting water to permeate and saturate the fault plane;
S3. applying, via a true-triaxial apparatus, stresses to the fault model to achieve a true-triaxial stress state where major, intermediate, and minor principal stresses are all unequal; and maintaining the true-triaxial stress state for a duration of d min;
S4. switching the true-triaxial apparatus from a stress-controlled loading mode to a displacement-controlled loading mode, inducing spontaneous instability in the fault model, and calculating an interseismic period T; and
S5. performing, by setting a cycle count N, with T/N as a period, cyclic water injection by alternating between injecting water at a constant rate of e mL/min and not injecting water, or performing water injection at a constant rate of f mL/min at intervals corresponding to the interseismic period T, thereby investigating a mechanism of injection-induced seismicity.

In a further embodiment, controlling a tolerance of the fabricated side length of the cubic model within±m cm, and controlling an angular tolerance in cutting the fault plane within ±n degrees, to ensure accuracy of the model.

In a further embodiment, during water injection for saturating the fault plane, controlling a water injection rate within a range of g mL/min to h mL/min to ensure stability of the saturation process.

In a further embodiment, controlling an applied stress tolerance in the true-triaxial apparatus within ±×N, and controlling a stress loading rate at y MPa/min, to ensure accuracy and stability during the loading process.

In a further embodiment, during displacement-driven spontaneous fault instability, controlling a displacement rate within a range of z cm/min to w cm/min to achieve stable spontaneous fault instability.

In a further embodiment, during the process of the injection-induced seismicity, simultaneously monitoring parameters comprising water pressure variation measured at the pore-pressure monitoring boreholes, fault displacement, and stress change, and conducting a combined analysis.

The present invention provides the following technical effects and advantages:

The experimental method for fluid-injection-induced seismicity under true-triaxial stress conditions is capable of high-fidelity simulation in a laboratory environment of complex stress states characterized by differential triaxial stress representative of actual subsurface formations, as well as the complete process whereby fluid injection operations trigger fault instability and induce seismic events. By combining carefully designed fault model fabrication, true triaxial stress loading, and diverse water injection scheme configurations, the method overcomes the limitations of conventional experimental methods in simulating authentic formation stress conditions, yielding experimental results that accurately reflect real-world scenarios, thereby providing a reliable data foundation for in-depth research on the mechanisms of injection-induced seismicity.

By systematically varying parameters, including injection rate and cycle frequency, combined with displacement-driven spontaneous fault instability, the present invention comprehensively investigates the source physics mechanism of injection-induced seismicity. The method not only allows for the observation of macroscopic fault instability phenomena but also enables integrated analysis utilizing multiple, synchronously monitored datasets, including fluid pressure variations, fault displacement, and stress changes, to elucidate the intrinsic physical processes governing earthquake generation, thereby effectively filling the current knowledge gap regarding the source mechanism of injection-induced seismicity.

Based on the experimental results of the present invention, stakeholders can more accurately assess the seismic risk associated with subsurface fluid injection activities, enabling the formulation of scientifically sound and effective earthquake prevention and mitigation strategies, thereby reducing the threat of seismic disasters to human life, property safety, and the environment.

The experimental method provides a scientific basis for optimizing a water injection protocol. By simulating the impacts of different water injection schemes on fault stability, industrial practitioners can select safer and more rational water injection parameters to avoid inducing seismic events due to improper injection operations, thereby ensuring the operational safety of industrial activities and promoting the sustainable development of the energy industry. The experimental method for fluid-injection-induced seismicity under true-triaxial stress conditions enables precise simulation of in-situ formation stress and injection conditions, providing a reliable method to study injection-induced seismicity, thereby holding significant implications for seismicity prediction, geohazard prevention and control, and related industrial safety.

### BRIEF DESCRIPTION OF THE DRAWINGS

To more clearly illustrate the embodiments of the present invention or the technical solutions in the prior art, the drawings required for describing the embodiments or the prior art are briefly introduced below. It is to be understood that the drawings in the following description depict some embodiments of the present invention. For those of ordinary skill in the art, other drawings may be derived from the drawings without creative efforts.

FIG. 1 is a schematic diagram of a true-triaxial loading system according to the present invention;

FIG. 2 is a schematic diagram of a water injection model according to the present invention;

FIG. 3 is a flow diagram of an experimental method according to the present invention; and

FIG. 4 is a schematic diagram of loading results according to the present invention.

In the drawings, 1. fault plane; 2. true-triaxial loading frame; 3. high-precision high-pressure water pump; 4. water-injection borehole; and 5. pore-pressure monitoring borehole.

### DETAILED DESCRIPTION OF THE EMBODIMENTS

In the following detailed description, numerous specific details are set forth to provide a thorough understanding of the present invention. However, it will be apparent to a person of ordinary skill in the art that the present invention may be practiced without one or more of these specific details. In other instances, well-known features or conventional aspects of the art have not been described in detail in order to avoid obscuring the present invention.

Unless otherwise explicitly defined herein, the directional terms such as upper, lower, left, right, front, rear, inner, and outer used throughout the specification shall be construed relative to the orientation depicted in the accompanying drawings of the present invention.

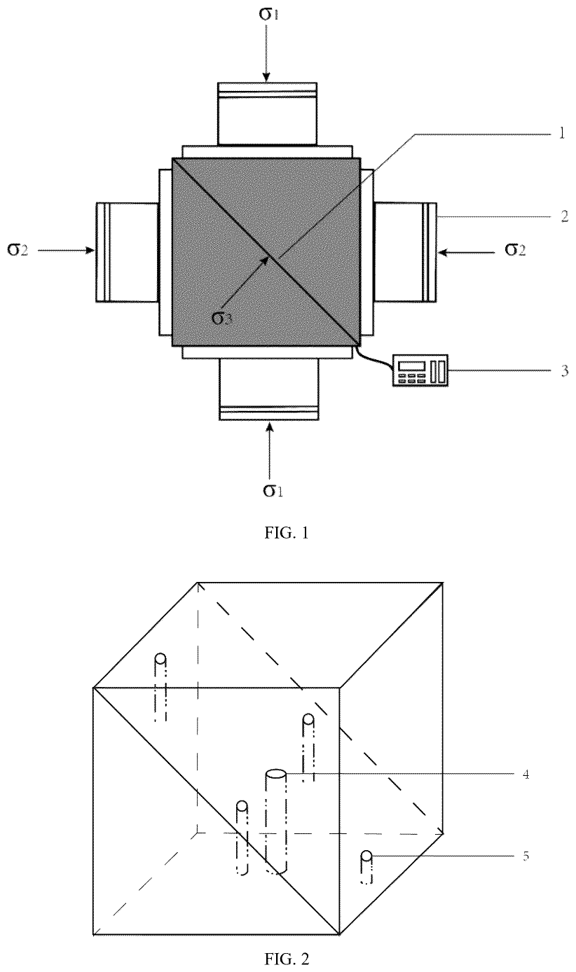

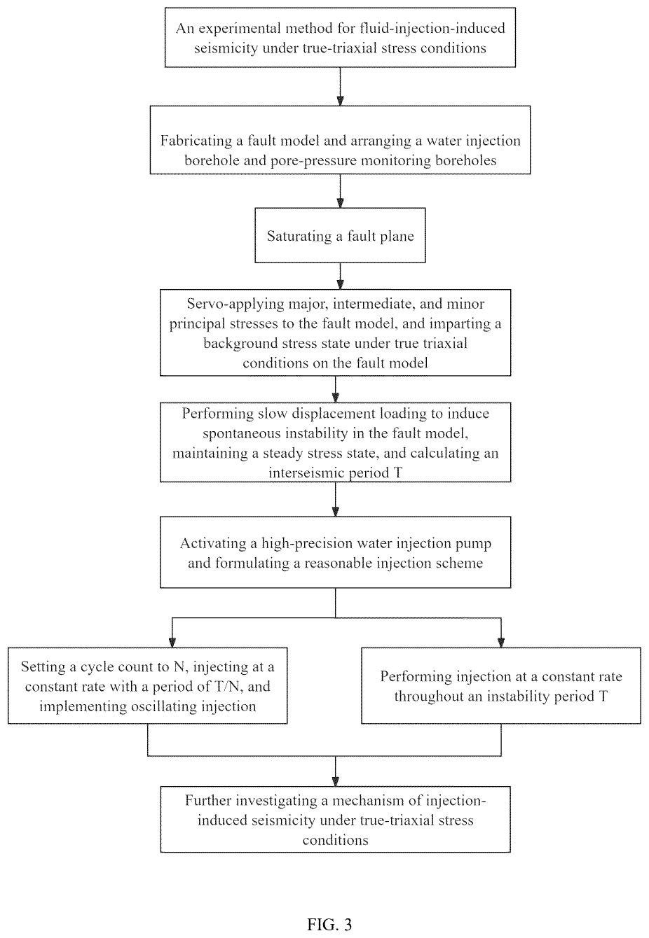

The present invention provides an experimental method for fluid-injection-induced seismicity under true-triaxial stress conditions, as shown in FIGS. 1-4, including the following steps:
1. Fault model fabrication and borehole layout:

A cubic model with edge dimensions of a cm×a cm×a cm is fabricated from premium-grade rock material using a high-precision cutting apparatus. The cubic rock sample containing a fault is precisely cut along a diagonal to obtain a fault plane 1 with dimensions of \sqrt{2a}×a cm. During the cutting process, the cutting accuracy is strictly controlled to ensure the flatness and the angular tolerance of the fault plane are maintained within an extremely small range, thereby guaranteeing the accuracy of the experimental results.

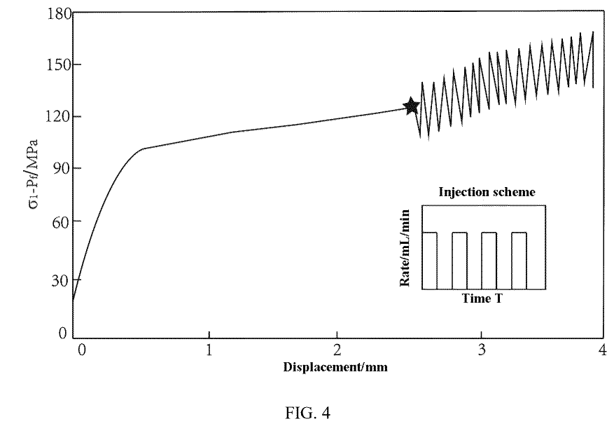

At the center of the footwall, a water-injection borehole 4 with a diameter of b cm is drilled from the bottom toward the fault plane. During the drilling operation, specialized drilling techniques and cooling protocols are employed to ensure borehole quality and thereby prevent the mechanical properties of the rock from being undesirably compromised by thermal effects or mechanical damage incurred during the drilling operation. Concurrently, water pressure monitoring holes 5 with a diameter of c cm are drilled at uniformly selected locations along the fault surface, to ensure uniform distribution of the monitoring holes for comprehensive monitoring of water pressure variations. The locations for the water pressure monitoring holes are selected based on numerical simulation and prior experimental experience, so as to enable the pore-pressure monitoring boreholes to accurately detect critical water pressure variations at the fault plane.
2. Fault plane permeation treatment: a high-precision high-pressure pump 3 is operatively coupled to the water-injection borehole 4. The high-precision high-pressure pump 3 is activated to introduce water at a stable, low speed. The bottom of the footwall is closely monitored during water injection. Water injection is stopped when saturation of the fault plane is determined based on water slowly seeping from the bottom. During the permeation process, the injection flow rate and water pressure are monitored in real-time by a high-accuracy flow sensor and a pressure sensor, whereby stability and controllability of the water permeation process are ensured.
3. True triaxial servo loading: the fault model is subjected to stress loading via a true-triaxial loading frame 2 to achieve a true-triaxial stress state characterized by unequal major, intermediate, and minor principal stresses. During the loading process, stress variations are monitored in real-time. Loading rate and magnitude are adjusted to maintain stable and precise loading operations. The loaded stress state is maintained for d min after completion of loading to achieve stress equilibrium. During the stress loading process, actual formation stress data and geomechanical models are referenced in accordance with a substantial body of data, and stress values are set rationally to realistically simulate the background stress state of faults within an actual subsurface environment.
4. Displacement-driven spontaneous fault instability: the true-triaxial apparatus is switched to a displacement loading mode. A displacement rate is adjusted to a reasonable value. The fault model is actuated to undergo spontaneous instability. The interseismic period T is accurately calculated after the occurrence of three stick-slip events in the fault model. During displacement-driven processes, changes in fault displacement and applied force are monitored in real time by high-precision displacement sensors and force sensors, thereby providing reliable data for accurate calculation of the interseismic period.
5. Laboratory seismicity induced by fluid injection: the high-precision high-pressure injection pump is activated, with a circulation count set to N, with a duration of T/N. Cyclic water injection is performed by alternating between injection at a constant rate of e mL/min and non-injection intervals. By observing a relationship between effective stress on a displacement drive shaft and fault displacement (as illustrated in FIG. 4), the mechanism of injection-induced seismicity and factors influencing the mechanism are analyzed. During a fluid injection process, synchronous monitoring is performed for multiple datasets, including water pressure changes along fault planes, fault displacements, and stress variations. A multi-parameter joint analysis method is utilized to comprehensively and deeply investigate the physical mechanism of injection-induced seismicity.

In practicing the present invention, the following principles shall be adhered to with respect to the understanding and use of relevant terms:

Orientation terms including “upper”, “lower”, “left”, “right”, “front”, “rear”, “top'', “bottom”, “inner”, “outer”, “vertical”, “horizontal”, ”transverse'', and “longitudinal”0 are defined with reference to the orientation shown in the accompanying drawings. These terms are used herein principally to describe the present invention and embodiments thereof and are not to be construed as limiting the indicated apparatus, elements, or components to a specific orientation, or as requiring that they be manufactured, assembled, or operated in a specific orientation. Moreover, these terms may also have other meanings in certain contexts. For example, the term “upper” may, in specific situations, denote an attachment relationship or a connection relationship. A person skilled in the art should correctly interpret their meanings depending on the specific circumstances. In practical experimental operations, directional terms shall be accurately and consistently utilized based on the experimental setup configuration and operational procedures to ensure precise and standardized experimental operations.

Connection terms, including “mounted”, “disposed”, “provided with”, “connected”, and “coupled” shall be construed broadly. Such connections encompass: (i) fixed attachment, detachable joining, or integrally formed construction; (ii) mechanical coupling or electrical interconnection; and (iii) direct attachment, indirect linkage through an intervening medium, or internal communication between two components. A person of ordinary skill in the art should interpret the specific meanings of the aforementioned terms in the present invention based on the particular circumstances. In the course of setting up and adjusting the experimental apparatus, the connection method should be appropriately selected according to the experimental requirements and the characteristics of the equipment to ensure the operational stability and reliability of the apparatus.

Distinguishing Terms: the terms “first”, “second”, and the like are used herein primarily to distinguish different apparatuses, elements, or components (which may or may not be identical in type and construction) and are not intended to indicate or imply relative importance or sequence of the referenced apparatuses, elements, or components. Unless otherwise specified, “a plurality” means two or more. In recording and analyzing experimental data, these distinguishing terms shall be accurately used to facilitate classified management and comparative analysis of different experimental subjects and data, thereby enhancing the accuracy and reproducibility of experimental data.

In the description of embodiments of the present invention, the technical solution shall be clearly and completely understood and applied. The embodiments described above are merely part of the embodiments of the present invention, but not all of the embodiments. All other embodiments obtainable by a person of ordinary skill in the art based on the embodiments disclosed herein without creative efforts shall fall within the scope of the present invention.

1. An experimental method for fluid-injection-induced seismicity under true-triaxial stress conditions, comprising steps of:
S1: fabricating a cubic rock model with side lengths of a cm×a cm×a cm using rock material, diagonally cutting the cubic rock model along a diagonal plane to form a fault plane, drilling a water-injection borehole from a center of a footwall bottom toward the fault plane, and uniformly arranging pore-pressure monitoring boreholes along the fault plane;
S2: coupling a high-precision high-pressure water pump to the water-injection borehole and injecting water to permeate and saturate the fault plane;
S3: applying, via a true-triaxial apparatus, stresses to the fault model to achieve a true-triaxial stress state where major, intermediate, and minor principal stresses are all unequal; and maintaining the true-triaxial stress state for a duration of d min;
S4: switching the true-triaxial apparatus from a stress-controlled loading mode to a displacement-controlled loading mode, inducing spontaneous instability in the fault model, and calculating an interseismic period T; and
S5: performing, by setting a cycle count N, with T/N as a period, cyclic water injection by alternating between injecting water at a constant rate of e mL/min and not injecting water, or performing water injection at a constant rate of f mL/min at intervals corresponding to an interseismic period T, thereby investigating a mechanism of injection-induced seismicity.

2. The experimental method for fluid-injection-induced seismicity under the true-triaxial stress conditions according to claim 1, wherein a tolerance of the fabricated side lengths of the cubic rock model is controlled within ±m cm, and an angular tolerance in cutting the fault plane is controlled within ±n degrees, to ensure accuracy of the model.

3. The experimental method for fluid-injection-induced seismicity under the true-triaxial stress conditions according to claim 1, wherein during water injection for saturating the fault plane, a water injection rate is controlled within a range of g mL/min to h mL/min to ensure stability of a saturation process.

4. The experimental method for fluid-injection-induced seismicity under the true-triaxial stress conditions according to claim 1, wherein an applied load precision in the true-triaxial apparatus is controlled within ±×N, and a stress loading rate is controlled at y MPa/min, to ensure accuracy and stability during a loading process.

5. The experimental method for fluid-injection-induced seismicity under the true-triaxial stress conditions according to claim 1, wherein during displacement-driven spontaneous fault instability, a displacement rate is controlled within a range of z cm/min to w cm/min to achieve stable spontaneous fault instability.

6. The experimental method for fluid-injection-induced seismicity under the true-triaxial stress conditions according to claim 1, wherein during a process of an injection-induced seismicity, parameters comprising water pressure variation measured at the pore-pressure monitoring boreholes, fault displacement, and stress change are simultaneously monitored, and a combined analysis is conducted.
